(19) United States
(12) Patent Application Publication
(10) Pub. No.: US 2004/0130444 A1
(43) Pub. Date: Jul. 8, 2004

(54) System for detecting intruders

(76) Inventors: Alexander Pakhomov, Yonkers, NY (US); E. Tim Goldburt, Chappaqua, NY (US)

Correspondence Address: Ilya Zborovsky, 6 Schoolhouse Way, Dix Hills, NY, 11746, US

(21) Appl. No.: 10/659,344

(22) Filed: Sep. 11, 2003

Related U.S. Application Data
(63) Continuation-in-part of application No. 09/788,238, filed on Feb. 16, 2001, now Pat. No. 6,664,894.

(51) Int. Cl. G08B 19/00

(52) U.S. Cl. 340/522

(57) ABSTRACT

A system for detecting of an intruder has a plurality of groups of sensors connected in parallel with one another, the sensors being selected from the group consisting of seismic sensors, acoustic sensors and both, a plurality of individual processing units each connected with a respective one of the groups of sensors, the individual processing units being connected in parallel with one another, a central processing unit connected with all the parallel-connected processing units so that each of the individual processing units can obtain information about a presence of an intruder near any of the groups of sensors, and means for obtaining a visual image of the intruder near any of the groups of sensors and transmitting the image to the central processing unit.

### CROSS-REFERENCE TO A RELATED APPLICATION

This application is a continuation-in-part of application Ser. No. 09/788,238.

### BACKGROUND OF THE INVENTION

The present invention relates to a system for detecting intruders.

More particularly, it relates to a system for detecting intruders, which has to provide a detection for intruders over a large areas and/or long distances.

Systems are known in with a plurality of sensors which detect the presence of an intruder. An additional processing equipment is connected with sensors and is complicated and expensive. When it is necessary to detect the intruders over long distances or over large areas, the equipment becomes even more complicated. It is believed to be advisable to provide a system which is less complicated, includes less components, and therefore is less expensive and also more reliable.

### SUMMARY OF THE INVENTION

Accordingly, it is an object of present invention to provide a system for detecting of intruders which is a further improvement of the existing systems.

In keeping with these objects and with others which will become apparent hereinafter, one feature of present invention resides, briefly stated, in a system for detecting of intruders which includes a plurality of groups of sensors, each group including a plurality of individual sensors; a plurality of processing units each connected with at least one said groups of said sensors; a central processing unit to which said individual processing units are connected by parallel connection, so that a central processing unit receives information about an intruder in an area of any of said sensors and of any of said groups of said sensors through a corresponding one of said individual processing units; and means for transmitting a video image of the intruder to said central processing unit.

When the system is designed in accordance with the present invention, it is substantially simplified, it contains less components, and is less expensive, and also can cover larger areas or greater distances.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a system for detecting intruders in accordance with one embodiment of present invention;

FIG. 2 is a view showing a system for detecting intruders in accordance with the another embodiment of the present invention; and

FIGS. 3 and 4 are views showing further embodiments of the present invention.

### DESCRIPTION OF PREFERRED EMBODIMENTS

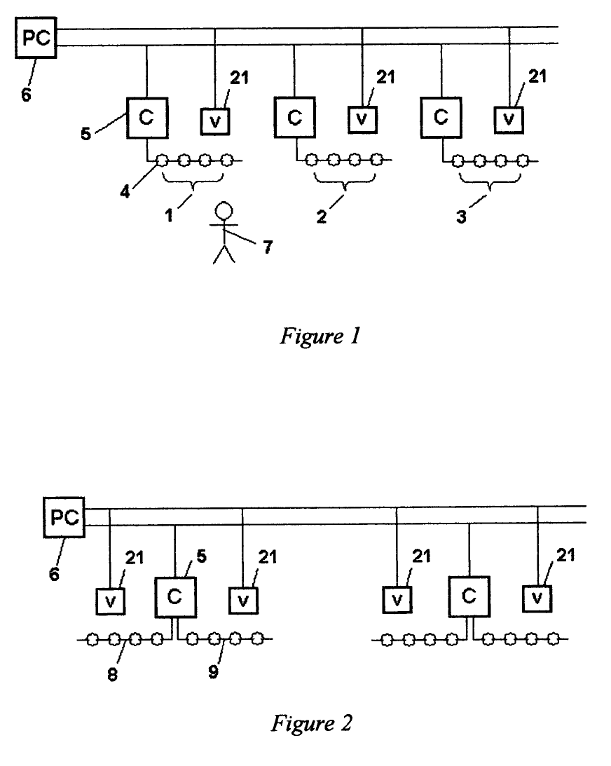

A system for detecting intruders in accordance with one embodiment of the present invention is shown in FIG. 1. It includes a plurality of groups of sensors which are identified with reference numerals 1, 2, 3, etc. Each group of sensors includes a plurality of individual sensors identified with reference numeral 4. The sensors 4 in each group are connected parallel with one another. Moreover, all sensors of each group are connected to a single processing unit 5.

In accordance with the present invention, all individual processing units are connected with a central processing unit which is identified with reference numeral 6. The individual processing units 5 are connected parallel with one another and to the central processing unit 6.

The system operates in the following manner. When an intruder 7 approaches for example any sensor of the group 1, the sensor which can be formed as an acoustic sensor, a seismic sensor, or a combined acoustic-seismic sensor produces a signal which can be a voltage and supplies it to the corresponding processing unit 5. In the processing unit the processing of the signal is performed. After the processing, the signal which identifies the presence of the intruder is supplied to the central processing unit 6. Every individual processing unit 5 has its own coded identification number which is also supplied to the central processing unit together with the signal of the presence of the intruder.

The central processing unit 6 therefore receives the signal of the intruder in the area of the corresponding group of sensors. The signal in the central processing unit can be printed out, can be presented as a table, or can be presented on a map which will identify an area where the intruder was detected. The central processing unit 6 can also form a protocol of the events related to the intruding over a certain period of time. It can activate or deactive of a corresponding one of the processing unit so as to activate or deactive corresponding groups of sensors in corresponding areas. It can also indicate corresponding parameters of the processing in a corresponding one of the processing units 5. The central processing 6 can also change parameters of the processing in a corresponding one of the processing units 5.

In the inventive system therefore it is not necessary to provide individual interfaces for each individual processing unit 5. It suffices to have one interface line between all processing units 5 and the central processing unit 6, which substantially simplifies the system, provides a possibility of increasing the area of detection of intruders, reduces the cost of the overall system.

In contrast to the prior art systems in which every sensor has its own processing unit connected with the central processing unit, the number of wires in the inventive system are dramatically reduced, and the number of information channels are decreased as well. Since a part of the processing procedure is concentrated in a central processing unit 6, it is no longer necessary to perform the whole procedure either in the processing units 5, or the central processing unit 6. Therefore, the central processing unit 6 can be simplified, it can have a lower energy consumption, and can be less expensive as well.

In accordance with the present invention in addition to the signals received from the corresponding sensors, also a visual image of an intruder can be obtained and submitted to the central processing unit. As shown in the drawings, at least one visual image detecting and transmitting unit 21 is located near each group of sensors. It can be formed as a video camera, it can include also more than one video camera such as for example a color TV and an infrared TV camera for night vision, it can also include a camera and a video capture device, etc. The visual image obtaining and transmitting units 21 are connected to the central processing unit as can be seen from the drawings.

When an intruder 7 approaches any of the groups of sensors, and the sensor of the group produces a signal, this signal is also supplied to the corresponding visual image obtaining and transmitting unit. The signal can be supplied directly from the corresponding sensor or the group of sensors, or the signal can be supplied from the central processing unit 6 when it receives a signal from the corresponding sensor or group of sensors. As a result, the visual image obtaining and transmitting unit is turned on, produces a visual image of an intruder, and sends it to the central processing unit. In the central processing unit a video signal is received, evaluated, if necessary processed, etc. to clearly see the intruder and to make determination of the situation.

As can be seen from FIG. 1, the individual video signal obtaining and transmitting means are connected parallel with one another and to the central processing unit 6. However, other ways of connections are possible as well. While in FIG. 1 it is shown that the video image obtaining and transmitting unit is located opposite to all sensors of each group, it can be located also in a different manner, as long as an area covered by the sensors of each group is also covered by a video receiving part of the video obtaining and transmitting unit.

FIG. 2 shows another embodiment of the present invention. In FIG. 2 each processing unit 5 is connected with two groups of sensors, such as groups 8 and 9. The processing unit 5 can have two processing channels so that the signals from the sensor group 8 and sensor group 9 are processed separately from one another and thereafter, the results of the processing are again submitted through the signal interface to the central processing unit 6. It further economizes on the connections and transmission channels, and also simplifies the transmission channels and simplifies in the construction.

In this embodiment also the visual image obtaining and transmitting units 21 are provided. Each of the visual image obtaining and transmitting units are associated with a corresponding one of the groups of sensors 8 and 9, so a to visualize an image of the intruder which approaches the corresponding group of sensors. The visual image obtaining and transmitting units 21 of this embodiment substantially corresponds to those of the embodiment of FIG. 1.

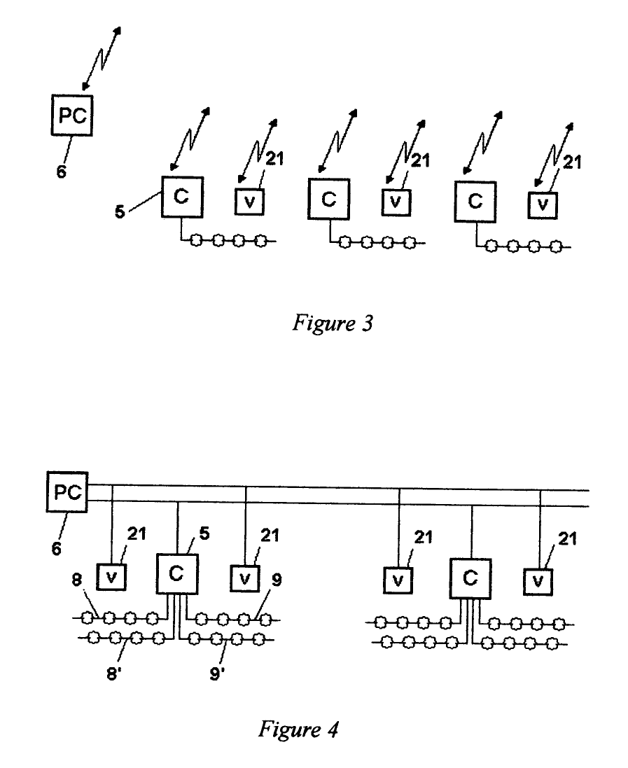

FIG. 3 shows still another embodiment of the present invention. Here the processing units are not connected with one another. Instead they are capable of transmitting information to the central processing unit in a wireless fashion, for example with the use of radio channels, or in other words via radio transmission.

In this embodiment also the visual image obtaining and transmitting units 21 are provided to visualize an intruder and to send a visual information to the central processing unit. A signal for turning on of the corresponding visual image obtaining and transmitting unit can be sent in a wireless fashion from the corresponding processing unit C. The visual image can be then transmitted to the central processing unit also in a wireless fashion.

FIG. 4 shows a further embodiment of the present invention. Here the groups of sensors 8 and 8′ extend substantially parallel to one another and are spaced from one another. They are both connected with the single processing unit 5 which can have different channels for processing of the signals from the sensor groups 8 and 8′. The processing unit 5 recognizes, from which sensor group 8 or 8′ the signal is received. As a result, it is possible to determine whether an intruder crosses the zone provided with the sensors from the side of the sensor group 8 or from the side of the sensor groups 8′. This is very important for detecting intruders which cross boarders from one country into another. The sensor groups 8 and 8′ can be laid along the country boarders for this purpose.

In this embodiment also the visual image obtaining and transmitting units 21 are provided. It is possible to provide one visual image obtaining and transmitting unit 21 for each pair of groups of sensors 8, 8′, 9, 9′, etc. However, it is of course possible to provide a different number of the visual image obtaining and transmitting units and at their different locations. Each visual image obtaining and transmitting units is turned on by a signal transmitted from the corresponding processing unit C, or from a signal by a corresponding sensor.

This approach is applicable for all above specified embodiments. The corresponding visual image obtaining and transmitting unit can be turned on either by a signal from a corresponding sensor approached by an intruder, or by a signal from the corresponding processing unit C to which the sensor approached by the intruder is connected, or by a signal from the central processing unit PC when it obtains a corresponding signal from the sensor or the processing unit C of the sensor.

It will be understood that each of the elements described above, or two or more together, may also find a useful application in other types of constructions differing from the types described above.

While the invention has been illustrated and described as embodied in system for detecting intruders, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for detecting of an intruder, comprising a plurality groups of sensors connected in parallel with one another, said sensors being selected from the group consisting of seismic sensors, acoustic sensors and both; a plurality of individual processing units each connected with a respective one of said groups of sensors; said individual processing units are connected in parallel with one another; a central processing unit connected with all said parallel-connected processing units so that each of said individual processing units can obtain information about a presence of an intruder near any of said groups of sensors; and means for obtaining a visual image of the intruder near any of said groups of sensors and transmitting the image to the central processing unit.

2. A system as defined in claim 1, wherein said at least two of said groups of sensors extend substantially in a same direction, are spaced from one another, and connected to a single respective one of said individual processing units, so that signals produced by said two groups of sensors and received by said respective one of said individual processing units are indicative of a direction from which an intruder crosses an area covered by said two groups of sensors; and means for obtaining a visual image of the intruder near any of said groups of sensors and transmitting the image to the central processing unit.

3. A system for detecting of an intruder, comprising a plurality groups of sensors connected in parallel with one another, said sensors being sensors selected from the group consisting of seismic sensors, acoustic sensors and both; a plurality of individual processing units each connected with a respective one of said groups of sensors; said individual processing units are connected in parallel with one another; a central processing unit connected with all said parallel-connected processing units by a single line so that each of said individual processing units can obtain information about a presence of an intruder near any of said group of sensors; and means for obtaining a visual image of the intruder near any of said groups of sensors and transmitting the image to the central processing unit.

4. A system for detecting of an intruder, comprising a plurality groups of sensors connected in parallel with one another, said sensors being sensors selected from the group consisting of seismic sensors, acoustic sensors and both; a plurality of individual processing units each connected with a respective one of said groups of sensors, each of said groups of sensors being connected with a respective one of said individual processing units by a single line; said individual processing units are connected in parallel with one another; a central processing unit connected with all said parallel-connected processing units by a single line so that each of said individual processing units can obtain information about a presence of an intruder near any of said group of sensors; and means for obtaining a visual image of the intruder near any of said groups of sensors and transmitting the image to the central processing unit.

5. A system for detecting of an intruder, comprising a plurality groups of sensors connected in parallel with one another, said sensors being sensors selected from the group consisting of seismic sensors, acoustic sensors and both; a plurality of individual processing units each connected with a respective one of said groups of sensors; said individual processing units are connected in parallel with one another; a central processing unit connected with all said parallel-connected processing units by a single line so that each of said individual processing units can obtain information about a presence of an intruder near any of said group of sensors, each of said groups of sensors being connected with a respective one of said individual processing units by a single line; and means for obtaining a visual image of the intruder near any of said groups of sensors and transmitting the image to the central processing unit.
